(19) United States
(12) Patent Application Publication
(10) Pub. No.: US 2014/0126958 A1
(43) Pub. Date: May 8, 2014

(54) LOCKING MECHANISM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: CHENG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,740

(22) Filed: Oct. 22, 2013

(30) Foreign Application Priority Data
Nov. 7, 2012 (CN) 2012104398894

(51) Int. Cl. F16B 41/00

(52) U.S. Cl. CPC F16B 41/002
USPC 403/328

(57) ABSTRACT

A locking mechanism is disclosed. The locking mechanism includes a locking member, a guiding member, three engaging members, and an elastic member. Three receiving holes are defined in an outer side surface of the locking member. The guiding member is slidably and partly received in the locking member. The guiding member comprises a latching portion. Each engaging member is received in the corresponding receiving hole. One end of the elastic member resists against the guiding member, such that the engaging member is latched by the latching portion and partly protrudes out from the receiving hole.

### BACKGROUND

1. Technical Field

The present disclosure relates to locking mechanisms, and particularly to a locking mechanism that can be locked and unlocked with a high efficiency.

2. Description of the Related Art

A number of screws is used for locking two workpieces together. However, when locking or unlocking the two workpieces, it is time-consuming and inefficient to screw or unscrew the screws.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric, assembled view of one embodiment of a locking mechanism.

FIG. 2 is a cross-sectional view of the locking mechanism, taken along line II-II of FIG. 1.

FIG. 3 is an isometric, exploded view of the locking mechanism of FIG. 1.

FIG. 4 shows the locking mechanism in a state of use.

FIG. 5 is a cross-sectional view of another embodiment of a locking mechanism.

### DETAILED DESCRIPTION

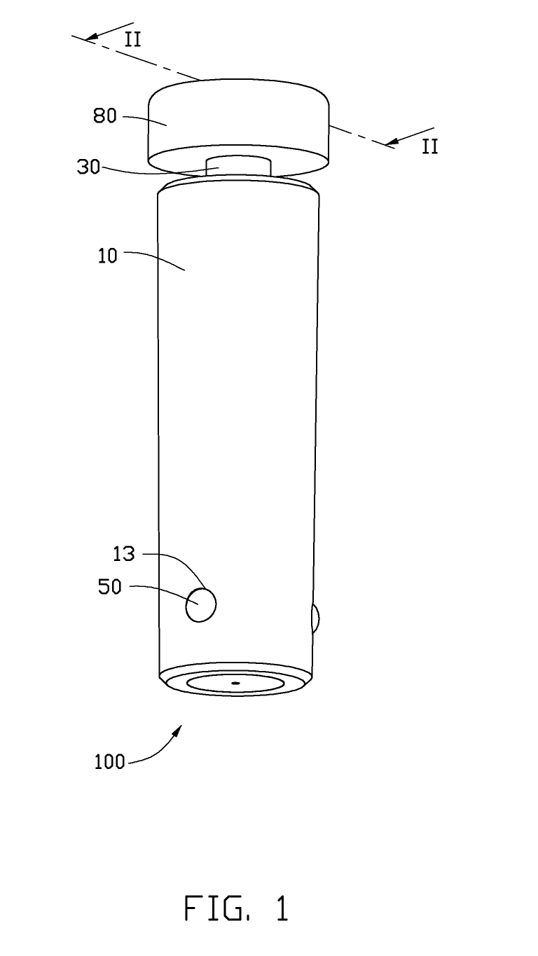

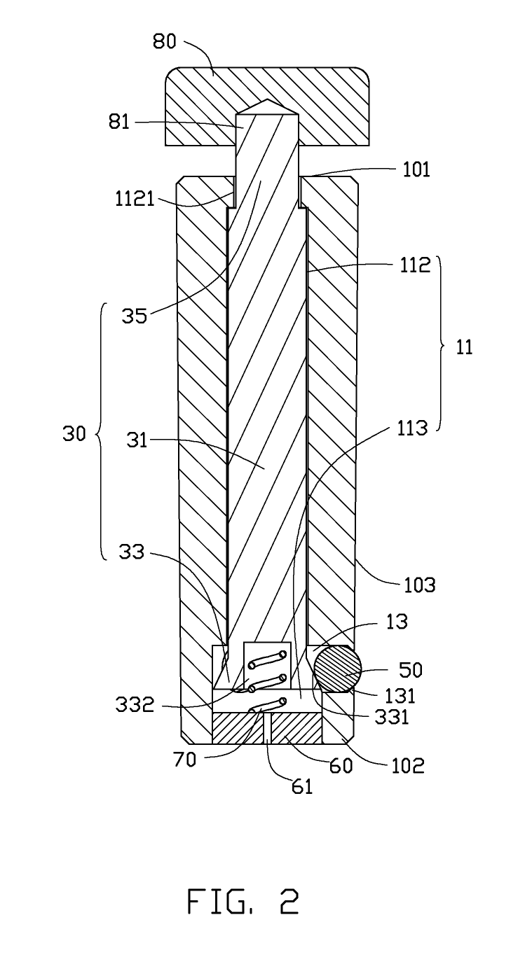

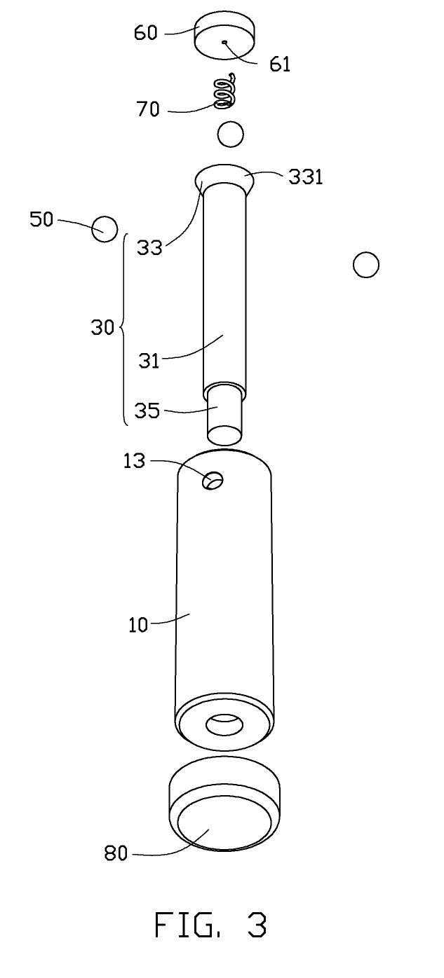

FIGS. 1 through 3 show an embodiment of a locking mechanism 100. The locking mechanism 100 includes a locking member 10, a guiding member 30, three engaging members 50, a cover 60, an elastic member 70, and a pressing member 80.

The locking member 10 is substantially a hollow conical frustum. A through hole 11 is axially defined in a center of the locking member 10. The through hole 11 includes a guiding hole 112 defined in a first end 101 of the locking member 10 and a mounting hole 113 defined in a second end 102 of the locking member 10. The guiding hole 112 communicates with the mounting hole 113. An outer diameter of the locking member 10 gradually decreases from the first end 101 to the second end 102. In the illustrated embodiment, a diameter of the guiding hole 112 is smaller than that of the mounting hole 113. A stop portion 1121 protrudes into an end of the guiding hole 112 away from the mounting hole 113. Three receiving holes 13 are defined around a circumference of an outer side surface 103 of the locking member 10 communicating to the mounting hole 113, and are spaced from each other. A distance between each receiving hole 13 and the second end 102 of the locking member 10 is substantially the same. Each receiving hole 13 has a positioning portion 131 formed therein. The positioning portion 131 includes a first resisting surface 1312 adjacent to the outer side surface 103. The first resisting surface 1312 is inclined, such that a size of the receiving hole 13 decreases along a direction away from the axis of the locking member 10.

The guiding member 30 is slidably mounted in the locking member 10 and is substantially a stepped cylinder. The guiding member 30 includes a guiding portion 31, a latching portion 33, and a connection portion 35. The latching portion 33 and the connection portion 35 extend from opposite ends of the guiding portion 31, respectively. The guiding portion 31 is slidably received in the guiding hole 112, such that one end of the guiding portion 31 adjacent to the connection portion 35 resists against the stop portion 1121. The latching portion 33 is substantially a conical frustum, and is slidably and partly received in the receiving holes 13. An outer diameter of the latching portion 33 increases along an axial direction away from the guiding portion 31. The latching portion 33 includes a second resisting surface 331. The engaging members 50 are latched between the second resisting surface 331 and the first resisting surfaces 1312 of the receiving holes 13. The latching portion 33 defines a positioning hole 332 in a center thereof. The connection portion 35 is substantially cylindrical and has a smaller diameter than that of the guiding portion 31, such that the connection portion 35 extends beyond the stop portion 1121 and protrudes out from the guiding hole 112.

Each engaging member 50 is substantially spherical and is received in one corresponding receiving hole 13. Each engaging member 50 is latched between the second resisting surface 331 and the first resisting surfaces 1312 of the receiving holes 13 and partly protrudes out from the receiving hole 13.

The cover 60 is securely received in a distal end of the mounting hole 113. That is to say, the cover 60 is securely positioned on the second end 102 of the locking member 10. The cover 60 defines a through hole 61 communicating with the mounting hole 113.

The elastic member 70 is received in the mounting hole 113 and the positioning hole 332, such that opposite ends of the elastic member 70 resist against the cover 60 and a bottom surface of the positioning hole 332, respectively. One end of the elastic member 70 is fixed to the cover 60. In the illustrated embodiment, the elastic member 70 is a compression spring.

The pressing member 80 is substantially cylindrical. A fixing hole 81 is defined in a center of a bottom surface of the pressing member 80, such that the connection portion 35 is securely received in the fixing hole 81 and fixed to the pressing member 80.

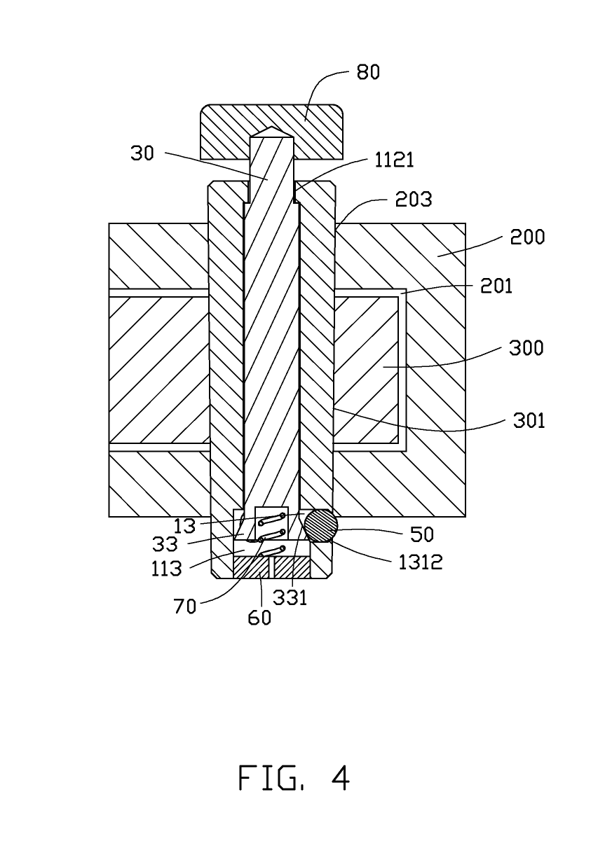

FIG. 4 shows the locking mechanism 100 in a state of use for locking a first workpiece 200 and a second workpiece 300 together. In the illustrated embodiment, the first workpiece 200 defines a receiving portion 201. Two first locking holes 203 are defined in opposite sidewalls of the receiving portion 201, respectively. The second workpiece 300 is received in the receiving portion 201, and defines a second locking hole 301 corresponding to the first locking hole 203. The first locking hole 203 and the second locking hole 301 communicate with each other, and cooperatively define a conical hole matching the outer side surface 103 of the locking member 10, such that a locking accuracy of the two workpieces 200, 300 is improved.

In use, before the locking member 10 is received in the first locking holes 203 and the second locking hole 301, the pressing member 80 is pressed downward, the elastic member 70 is compressed, and the latching portion 33 is moved toward the cover 60, such that the engaging members 50 can be fully received in the receiving holes 13. Next, the locking member 10 is received in the first locking holes 203 and the second locking hole 301. Then, the pressing member 80 is released (from being pressed downward), and the elastic member 70 is elastically restored to push the latching portion 33 away from the cover 60, such that the engaging members 50 are latched between the latching portion 33 and the positioning portion 131. The engaging members 50 partly protrude out from the receiving holes 13 and resist against the first workpiece 200. Thus, the first workpiece 200 and the second workpiece 300 are locked together.

When unlocking the first workpiece 200 from the second workpiece 300, the pressing member 80 is pressed downward (again), the elastic member 70 is compressed, and the latching portion 33 is moved toward the cover 60, such that the engaging members 50 are released from resisting against the workpiece 200, and can be fully received in the receiving holes 13. Next, the locking member 10 is pulled out from the first locking holes 203 and the second locking hole 301, such that the first workpiece 200 and the second workpiece 300 are unlocked from each other. Thus, when locking or unlocking the first workpiece 200 and the second workpiece 300, the use of screws is omitted, and a work efficiency is improved.

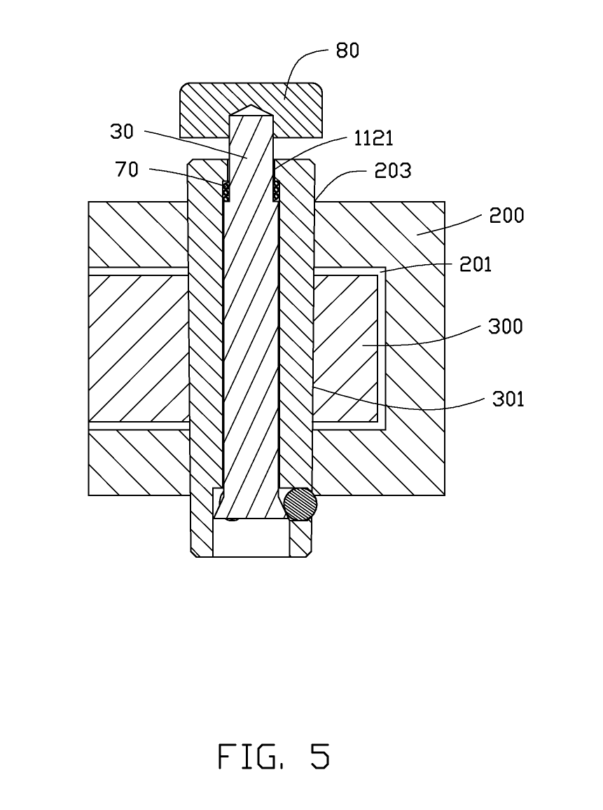

In other embodiments, a number of the engaging members 50 and a number of the receiving holes 13 can be correspondingly changed according to need. The stop portion 1121 can be omitted according to need, and the guiding hole 112 and the mounting hole 113 can have a substantially same diameter. The pressing member 80 can be omitted, such that the connection portion 35 is directly being pressed. The cover 60 can be omitted, such that the elastic member 70 is mounted between the stop portion 1121 and an end of the guiding portion 31 adjacent to the connection portion 35, as shown in FIG. 5, and the elastic member 70 is a tension spring.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A locking mechanism, comprising:
a locking member defining a through hole axially thereof, and at least one receiving hole defined in an outer side surface of the locking member communicating to the through hole;
at least one engaging member received in the at least one receiving hole;
a guiding member slidably and partly received in the through hole, the guiding member comprising a latching portion under the at least one engaging member; and
an elastic member received in the through hole, wherein one end of the elastic member resists against the guiding member, such that the at least one engaging member is latched by the latching portion and capable of partly protruding out from the at least one receiving hole.

2. The locking mechanism of claim 1, wherein each of the at least one receiving hole forms a positioning portion adjacent to the outer side surface of the locking member, and the at least one engaging member is latched between the positioning portion and the latching portion.

3. The locking mechanism of claim 2, wherein the positioning portion comprises a first resisting surface adjacent to the outer side surface of the locking member, and the first resisting surface is inclined.

4. The locking mechanism of claim 1, wherein a size of the receiving hole decreases along a direction away from the axis of the locking member.

5. The locking mechanism of claim 1, wherein a stop portion is formed on an inner side surface of the locking member, and opposite ends of the elastic member resist against the stop portion and the guiding member, respectively.

6. The locking mechanism of claim 1, wherein the locking mechanism further comprises a pressing member, and the pressing member is fixed to one end of the guiding member away from the latching portion.

7. The locking mechanism of claim 1, wherein a fixing hole is defined in a bottom surface of the pressing member, and one end of the guiding member away from the latching portion is fixedly received in the fixing hole.

8. The locking mechanism of claim 1, wherein the locking member is substantially a hollow conical frustum, an outer diameter of the locking member gradually increases in a direction away from the end of the locking member adjacent to the at least one receiving hole.

9. The locking mechanism of claim 1, wherein the locking mechanism further comprises a cover, the cover is securely positioned on the end of the locking member adjacent to the at least one receiving hole.

10. The locking mechanism of claim 9, wherein the latching portion defines a positioning hole, one end of the elastic member is received in the positioning hole, and resists against a bottom surface of the positioning hole, the other end of the elastic member resists against the cover.

11. The locking mechanism of claim 9, wherein the cover defines a through hole communicating to the through hole of the locking member.

12. A locking mechanism, comprising:
a locking member, the locking member being a hollow conical frustum, and a receiving hole defined in an outer side surface of the locking member communicating to the through hole, a size of the receiving hole decreases along a direction away from an axis of the locking member;
a guiding member slidably and partly received in the locking member, the guiding member comprising a latching portion;
an engaging member received in the receiving hole; and
an elastic member, wherein one end of the elastic member resists against the guiding member, such that the engaging member is latched by the latching portion and capable of partly protruding out from the receiving hole.

13. The locking mechanism of claim 12, wherein the receiving hole forms a positioning portion adjacent to the outer side surface of the locking member, the engaging member is latched between the positioning portion and the latching portion.

14. The locking mechanism of claim 13, wherein the positioning portion comprises a first resisting surface adjacent to the outer side surface of the locking member, and the first resisting surface is inclined.

15. The locking mechanism of claim 12, wherein a stop portion is formed on an inner side surface of the locking member, opposite ends of the elastic member resist against the stop portion and the guiding member, respectively.

16. The locking mechanism of claim 12, wherein the locking mechanism further comprises a pressing member, the pressing member is fixed to one end of the guiding member away from the latching portion.

17. The locking mechanism of claim 12, wherein a fixing hole is defined in a bottom surface of the pressing member, the end of the guiding member away from the latching portion is fixedly received in the fixing hole.

18. The locking mechanism of claim 12, wherein the locking mechanism further comprises a cover, the cover is securely positioned on the end of the locking member adjacent to the receiving hole.

19. The locking mechanism of claim 18, wherein the latching portion defines a positioning hole, one end of the elastic member is received in the positioning hole, and resists against a bottom surface of the positioning hole, the other end of the elastic member resists against the cover.

20. The locking mechanism of claim 12, wherein the latching portion is substantially a conical frustum.
